(19) United States
(12) Patent Application Publication
(10) Pub. No.: US 2024/0319691 A1
(43) Pub. Date: Sep. 26, 2024

(54) METHOD FOR CONTROLLING A MEASURING DEVICE AND MEASURING DEVICE

(71) Applicant: NETZSCH-Gerätebau GmbH, Selb (DE)

(72) Inventors: Martin BRUNNER, Konradsreuth (DE); Thomas DENNER, Selb (DE); Thilo HILPERT, Selb (DE); Fabian WOHLFAHRT, Rehau (DE); Michael SCHÖNEICH, Selb (DE); Michael MÜLLER, Trabitz (DE); Thorsten HACHMANN, Thierstein (DE)

(21) Appl. No.: 18/609,251

(22) Filed: Mar. 19, 2024

Related U.S. Application Data
(60) Provisional application No. 63/453,485, filed on Mar. 21, 2023.

(30) Foreign Application Priority Data
Mar. 21, 2023 (DE) 102023107031.2

(51) Int. Cl. G05B 15/02

(52) U.S. Cl. CPC G05B 15/02

(57) ABSTRACT

A method for controlling a measuring device includes receiving, by a controller, a request to perform a specific measurement, establishing, by the controller, a measurement schedule of the steps to be performed for the specific measurement, and outputting, by the controller, the established measurement schedule to a user of the measuring device. A measuring device is also disclosed.

### TECHNICAL FIELD

The disclosure herein relates to a method for controlling a measuring device and to a measuring device.

### BACKGROUND

The determination of properties of different materials is of major importance for many applications in research and industry. For this purpose a variety of measuring devices are used which, depending on the application, sometimes provide very complex measuring processes.

Performing these measurements by a user requires a certain level of expertise, since ensuring the successful completion of the desired measurement involves taking into account the technical and scientific background of the individual measurement processes.

This can also lead to a situation in which performing a measurement requires not only pure measuring time, but also a sometimes long preparation time, during which a user of the measuring device to be applied must plan and prepare the measuring procedure themselves.

### SUMMARY

Against this background, it is the object of the disclosure herein to facilitate the use of measuring devices and to make them more efficient.

This task is solved by a method and by a measuring device having features disclosed herein.

Accordingly, a method for controlling a measuring device is provided. The method comprises receiving a request to perform a specific measurement by a controller, establishing a measurement schedule of the steps to be performed for the specific measurement by the controller, and outputting the established measurement schedule to a user of the measuring device by the controller.

Furthermore, a measuring device is provided which is configured to perform the method according to the disclosure herein.

It is an underlying idea of the disclosure herein that the user of the measuring device is supported by a controller designed for this purpose. As the controller takes over the task of establishing the measurement schedule, this step of measurement preparation can be considerably shortened. The output of the measurement schedule to the user, which can also be carried out during the measurement process, additionally relieves the user during the performance of the measurement.

According to one embodiment of the method, the controller accesses a database when establishing the measurement schedule. The establishing of a suitable measurement schedule can be advantageously supported by a suitable design of the database.

According to a further development of the method, the database comprises a plurality of ready-made measurement schedules, from which the controller selects one. This is an advantageously simple database design that provides fast and reliable results.

According to a further development of the method, the database comprises a plurality of information about material properties and measurement methods, wherein the controller autonomously establishes the measurement schedule based on this plurality of information. As a result, the controller can advantageously support a plurality of hypothetically possible measurements.

According to one embodiment of the method, the controller updates the database after the measurement has been performed. As a result, knowledge gained during a measurement can be used to advantage for future measurements.

According to one embodiment of the method, the established measurement schedule comprises a plurality of measurement steps, which are individually output to the user. As a result, the user is supported in performing the measurement, as not too much information is output at once.

According to a further development of the method, the user must confirm that a measurement step has been performed before the subsequent measurement step is output. As a result, the controller can provide even more advantageous support when performing the measurement, as it can be ensured that each measurement step is performed correctly.

According to an embodiment example of the method, the outputting of the established measurement schedule is carried out by an outputting device of the measuring device. Focusing the output on a specific area can make it easier for the user to receive the output information.

According to an example embodiment of the method, outputting the established measurement schedule comprises highlighting at least one component, in particular an inputting device or a sample receiving device, of the measuring device. As a result, the user is supported even more advantageously, as their attention is specifically directed by the controller.

### BRIEF DESCRIPTION OF THE DRAWINGS

The disclosure herein is explained below with reference to the figures of the drawings. In the figures:

FIG. 1 is a schematic flow diagram for a method according to an example embodiment of the disclosure herein;

FIG. 2 is a schematic representation of a measuring device according to an example embodiment of the disclosure herein; and

FIG. 3 is a schematic representation of a system with a plurality of measuring devices according to an example embodiment of the disclosure herein.

In the figures, the same reference signs designate identical or functionally identical components, unless indicated to the contrary.

### DETAILED DESCRIPTION

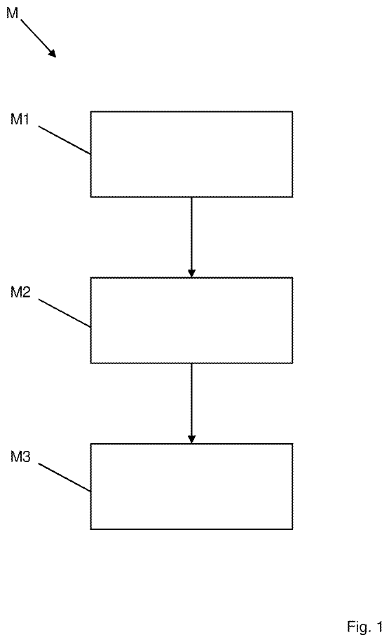

FIG. 1 shows a schematic flow diagram for a method M for controlling a measuring device according to an example embodiment of the disclosure herein.

In a first method step M1, a controller receives a request to perform a specific measurement. In a further method step M2, the controller establishes a measurement schedule of the steps to be performed for the specific measurement. In a further method step M3, the controller outputs the established measurement schedule to a user of the measuring device.

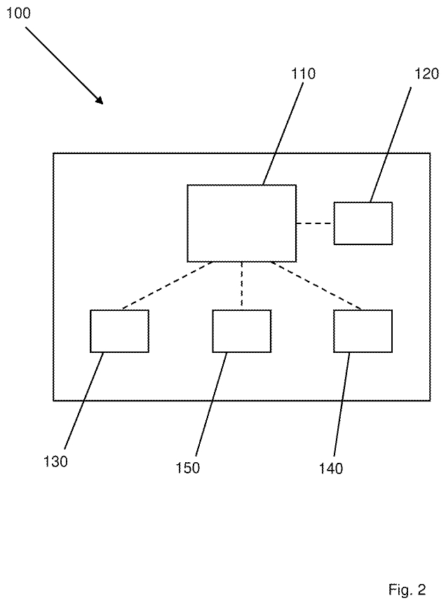

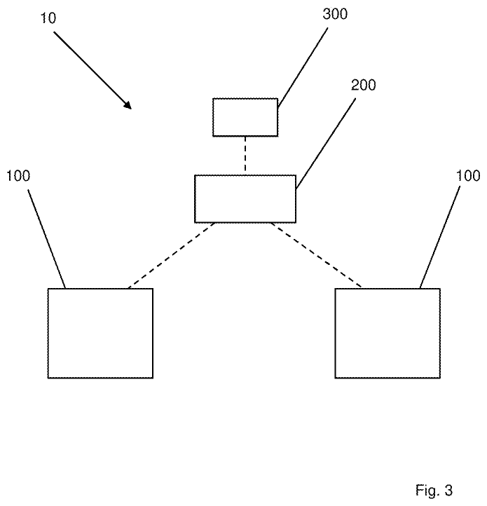

The method M shown is described in detail below with reference to FIGS. 2 and 3.

FIG. 2 shows a schematic representation of a measuring device 100 according to an example embodiment of the disclosure herein.

The measuring device 100 comprises a controller 110, a database 120, an outputting device 130, an inputting device 140, and a sample receiving device 150.

In the example embodiment shown here, the controller 110 is integrated into the measuring device 100 and is configured to receive a request to perform a specific measurement. This request can be transmitted by a user of the measuring device 100 to the controller 110, for example via the inputting device 140 of the measuring device 100. The inputting device 140 may comprise, for example, a keyboard, a touch screen or the like. Alternatively, the request can also be transmitted to the controller 110 via an external interface.

The controller 110 is further configured to establish a measurement schedule in response to the request received as to which steps are to be performed for the specific measurement. For this purpose, the controller 110 can access the database 120, which in the present example embodiment is configured in the form of an internal memory of the measuring device 100. In this regard, the database 120 may comprise a plurality of predetermined measurement schedules. In this case, the controller 110 establishes the measurement schedule for the specific measurement by selecting one of the predetermined measurement schedules in the database. Alternatively or additionally, the database 120 may comprise a plurality of information about material properties and measurement methods. In this case, the controller autonomously establishes the measurement schedule based on this plurality of information.

The controller 110 is further configured to output the established measurement schedule to a user of the measuring device 100. For example, the outputting device 130 of the measuring device 100 can be used for this purpose. The outputting device 130 may comprise, for example, a screen and/or speakers for this purpose. For example, the outputting device 130 and the inputting device 140 may also be combined in a touchscreen. Alternatively or additionally, individually components of the measuring device 100, such as the inputting device 140 and the sample receiving device 150, can also be highlighted, for example by illuminating buttons to be actuated or the like.

In particular, the controller 110 may also be configured to update the database 120 after the specific measurement has been performed. The measurement results relating to the material properties of the sample used in the measurement can then be recorded in the database 120, for example, and are then available for future measurements and measurement schedules. Predetermined measurement schedules can also be revised, taking into account the measurement carried out. The information required for this regarding the measurement performed can either be transferred to the controller 110 by a user of the measuring device 100. Alternatively or additionally, the controller 110 can also receive the relevant information directly from the measuring device 100, or from sensors integrated in the measuring device 100.

One option for outputting an established measurement schedule can be to divide the measurement schedule into a plurality of individually performed measurement steps, which are output to the user one after the other, whereby a measurement step is only output once the foregoing step has been performed. Alternatively or additionally, the controller 110 may also be configured to prevent further steps from being performed until the user has confirmed that the current measurement step has been performed. The controller 110 can monitor the performance of the individually performed measurement steps directly, for example by sensors integrated into the measuring device 100.

The measuring device 100 can be configured in particular as a device for the thermal analysis of materials. In particular, the measuring device 100 may be configured for performing differential thermal analyses, dynamic differential calometry, dynamic mechanical analyses, thermomechanical analyses or the like. During such measuring processes, the support of a user by the controller 110 can be particularly advantageous.

FIG. 3 shows a schematic representation of a system 10 with a plurality of measuring devices 100 according to an example embodiment of the disclosure herein.

In the example embodiment shown, the system 10 comprises a total of two measuring devices 100, a controller 200 and a database 300.

The individually components of the system 10 can in principle be configured in exactly the same way as the corresponding components described with reference to FIG. 2. Only the controller 200 and the database 300 are configured as independent devices external to the two measuring devices 100 in the example embodiment shown here. In principle, however, the database 300 can also be configured as a sub-component of the controller 200.

Since the controller 200 is configured as a stand-alone device, it can be configured for use with either of the two measuring devices 100. In this configuration, the measurement schedule established by the controller 200 may include which of the measuring devices 100 is to be used.

FIG. 3 shows two measuring devices 100. However, any number of measuring devices 100 can be provided. In particular, it may also be foreseen to use an individually measuring device 100 with an external controller 200 and/or an external database 300.

The measuring devices 100 can be configured to have the same function or be configured to perform different measurements in each case. Depending on the application, this allows the respective measurement processes to be performed simultaneously or sequentially.

The database 300 is shown here as a specific component of the system 10. However, it is also conceivable that the controller 200 and/or the database 300 is connected to an extended network, in particular to the Internet, and obtains relevant information directly via this network instead of storing it locally.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 measuring device
110 controller
120 database
130 outputting device
140 inputting device
150 sample receiving device
200 controller
300 database
M method
M1 method step
M2 method step
M3 method step

1. A method for controlling a measuring device, comprising:
receiving a request to perform a specific measurement by a controller;
establishing by the controller a measurement schedule of steps to be performed for the specific measurement; and
outputting the established measurement schedule to a user of the measuring device by the controller.

2. The method according to claim 1, wherein the controller accesses a database when establishing the measurement schedule.

3. The method according to claim 2, wherein the database comprises a plurality of ready-made measurement schedules from which the controller selects one.

4. The method according to claim 2, wherein the database comprises a plurality of information about material properties and measurement methods, and the controller autonomously establishes the measurement schedule based on the plurality of information.

5. The method according to claim 2, wherein the controller updates the database after performing the measurement.

6. The method according to claim 1, wherein the measurement schedule established comprises a plurality of measurement steps which are individually outputted to the user.

7. The method according to claim 6, wherein the user must confirm that a measurement step has been performed before the subsequent measurement step is output.

8. The method according to claim 1, wherein the outputting of the established measurement schedule is carried out by an outputting device of the measuring device.

9. The method according to claim 1, wherein the outputting of the established measurement schedule comprises highlighting at least one component that comprises an inputting device or a sample receiving device, of the measuring device.

10. A measuring device configured to perform the method according to claim 1.
